(19) United States
(12) Patent Application Publication
(10) Pub. No.: US 2023/0343951 A1
(43) Pub. Date: Oct. 26, 2023

(54) COBALT-FREE, HIGH-POWER ELECTROCHEMICAL CELL

(71) Applicant: GM GLOBAL TECHNOLOGY OPERATIONS LLC, Detroit, MI (US)

(72) Inventors: Dewen KONG, Shanghai (CN); Haijing LIU, Shanghai (CN)

(73) Assignee: GM GLOBAL TECHNOLOGY OPERATIONS LLC, Detroit, MI (US)

(21) Appl. No.: 17/855,028

(22) Filed: Jun. 30, 2022

(30) Foreign Application Priority Data
Apr. 22, 2022 (CN) 202210432684.7

(51) Int. Cl. H01M 4/525; H01M 4/62; H01M 4/587; H01M 4/505; H01M 10/0525

(52) U.S. Cl. CPC H01M 4/525; H01M 4/623; H01M 4/587; H01M 4/505; H01M 10/0525; H01M 2004/028

(57) ABSTRACT

An electrochemical cell includes a positive electrode including 90 wt. % to 98 wt. % of a cobalt-free electroactive material. represented by LiNiₓM₁₋ₓO₂ (where M is manganese, aluminum, magnesium, zirconium, chromium, or a combination thereof and x≥0.75), 0.05 wt. % to 3 wt. % a polytetrafluoroethylene (PTFE) binder having a molecular weight (MW) greater than or equal to about 6,000,000 u, and 1 wt. % to 5 wt. % of a first electronically conductive material. The electrochemical cell also includes a negative electrode including 90 wt. % to 98 wt. % of a graphite-containing negative electroactive material, 0.05 wt. % to 3 wt. % a polytetrafluoroethylene (PTFE) binder having a molecular weight (MW) greater than or equal to about 6,000,000 u, 0.05 wt. % to 2 wt. % of an ancillary binder, and 1 wt. % to 5 wt. % of a second electronically conductive material.

### CROSS-REFERENCED TO RELATED APPLICATIONS

This application claims the benefit and priority of CN202210432684.7 filed Apr. 22, 2022. The entire disclosure of the above application is incorporated herein by reference.

### INTRODUCTION

This section provides background information related to the present disclosure which is not necessarily prior art.

Advanced energy storage devices and systems are in demand to satisfy energy and/or power requirements for a variety of products, including automotive products such as start-stop systems (e.g., 12V start-stop systems), battery-assisted systems, hybrid electric vehicles (“HEVs”), and electric vehicles (“EVs”). Typical lithium-ion batteries include at least two electrodes and an electrolyte and/or separator. One of the two electrodes may serve as a positive electrode or cathode and the other electrode may serve as a negative electrode or anode. A separator and/or electrolyte may be disposed between the negative and positive electrodes. The electrolyte is suitable for conducting lithium ions between the electrodes and, like the two electrodes, may be in solid and/or liquid form and/or a hybrid thereof. In instances of solid-state batteries, which include solid-state electrodes and a solid-state electrolyte, the solid-state electrolyte may physically separate the electrodes so that a distinct separator is not required.

### SUMMARY

This section provides a general summary of the disclosure, and is not a comprehensive disclosure of its full scope or all of its features.

The present disclosure relates to high power electrochemical cells, and more specifically, to cobalt free electrodes, and methods of making and using the same.

In various aspects, the present disclosure provides an electrochemical cell that cycles lithium ions. The electrochemical cell may include a positive electrode and a negative electrode. The positive electrode may include a cobalt-free electroactive material and a polytetrafluoroethylene (PTFE) binder having a molecular weight (MW) greater than or equal to about 6,000,000 u. The cobalt-free electroactive material may be represented by LiNiₓM₁₋ₓO₂, where M is selected from the group consisting of: manganese, aluminum, magnesium, zirconium, chromium, and combinations thereof, and where x≥0.75. The negative electrode may include a graphite-containing negative electroactive material and a polytetrafluoroethylene (PTFE) binder having a molecular weight (MW) greater than or equal to about 6,000,000 u.

In one aspect, the positive electrode may include greater than or equal to about 90 wt. % to less than or equal to about 98 wt. % of the cobalt-free electroactive material, and greater than or equal to about 1 wt. % to less than or equal to about 5 wt. % of the high molecular weight polytetrafluoroethylene (PTFE) binder.

In one aspect, the positive electrode may further include greater than or equal to about 1 wt. % to less than or equal to about 5 wt. % of an electronically conductive material.

In one aspect, the negative electrode may include greater than or equal to about 90 wt. % to less than or equal to about 98 wt. % of the graphite-containing negative electroactive material, and greater than or equal to about 0.05 wt. % to less than or equal to about 3 wt. % of the polytetrafluoroethylene (PTFE) binder.

In one aspect, the negative electrode may further include greater than or equal to about 0.05 wt. % to less than or equal to about 2 wt. % of an ancillary binder.

In one aspect, the ancillary binder is selected from the group consisting of: polyimide, polyamic acid, polyamide, polysulfone, polyvinylidene difluoride (PVdF), polyacrylic acid, blends of polyvinylidene fluoride and polyhexafluoropropene, polychlorotrifluoroethylene, ethylene propylene diene monomer (EPDM) rubber, carboxymethyl cellulose (CMC), a nitrile butadiene rubber (NBR), styrene-butadiene rubber (SBR), lithium polyacrylate (LiPAA), sodium polyacrylate (NaPAA), sodium alginate, lithium alginate, polyethylene oxide (PEO), and combinations thereof.

In one aspect, a mass ratio between the polytetrafluoroethylene (PTFE) binder and the ancillary binder may be about 0.5:5.

In one aspect, the negative electrode may further include greater than or equal to 1 wt. % to less than or equal to about 5 wt. % of an electronically conductive material.

In one aspect, the positive electrode may have a capacity loading of greater than or equal to about 4.0 mAh/cm² to less than or equal to about 10 mAh/cm², and the negative electrode may have a capacity loading of greater than or equal to about 4.2 mAh/cm² to less than or equal to about 12 mAh/cm².

In one aspect, the positive electrode may have a press density greater than or equal to about 2.5 g/cm³ to less than or equal to about 4.0 g/cm³, and a porosity greater than or equal to about 25 vol. % to less than or equal to about 45 vol. %.

In one aspect, the negative electrode may have a tap density greater than or equal to 0.5 g/cc to less than or equal to 1.3 g/cc, a press density greater than or equal to about 1.3 g/cm³ to less than or equal to about 1.9 g/cm³, and a porosity greater than or equal to about 28 vol. % to less than or equal to about 50 vol. %.

In one aspect, the positive electrode may have a first width greater than or equal to about 50 mm to less than or equal to about 500 mm, and a first length greater than or equal to about 50 mm to less than or equal to about 2,000 mm. The negative electrode may have a second width that is at least two times greater than a first width of the positive electrode, and a second length that is at least two times greater than a first length of the positive electrode.

In one aspect, the cobalt-free electroactive material may include LiNi_{0.75}Mn_{0.25}O₂ (NM75).

In one aspect, the cobalt-free electroactive material may include LiNi_{0.94}Mn_{0.04}Al_{0.02}O₂ (NMA).

In various aspects, the present disclosure provides an electrochemical cell that cycles lithium ions. The electrochemical cell may include a positive electrode and a negative electrode. The positive electrode may include greater than or equal to about 90 wt. % to less than or equal to about 98 wt. % of a cobalt-free electroactive material. The cobalt-free electroactive material may be represented by LiNiₓM₁₋ₓO₂, where M is manganese, aluminum, magnesium, zirconium, chromium, and a combination thereof and where x≥0.75. The positive electrode may also include greater than or equal to about 0.05 wt. % to less than or equal to about 3 wt. % of a polytetrafluoroethylene (PTFE) binder having a molecular weight (MW) greater than or equal to about 6,000,000 u. The negative electrode may include greater than or equal to about 90 wt. % to less than or equal to about 98 wt. % of a graphite-containing negative electroactive material. The negative electrode may also include greater than or equal to about 0.05 wt. % to less than or equal to about 3 wt. % of a polytetrafluoroethylene (PTFE) binder having a molecular weight (MW) greater than or equal to about 6,000,000 u, and greater than or equal to about 0.05 wt. % to less than or equal to about 2 wt. % of an ancillary binder.

In one aspect, the positive electrode may further include greater than or equal to about 1 wt. % to less than or equal to about 5 wt. % of an electronically conductive material.

In one aspect, the negative electrode may further include greater than or equal to 1 wt. % to less than or equal to about 5 wt. % of an electronically conductive material.

In one aspect, the ancillary binder may be selected from the group consisting of: polyimide, polyamic acid, polyamide, polysulfone, polyvinylidene difluoride (PVdF), polyacrylic acid, blends of polyvinylidene fluoride and polyhexafluoropropene, polychlorotrifluoroethylene, ethylene propylene diene monomer (EPDM) rubber, carboxymethyl cellulose (CMC), a nitrile butadiene rubber (NBR), styrene-butadiene rubber (SBR), lithium polyacrylate (LiPAA), sodium polyacrylate (NaPAA), sodium alginate, lithium alginate, polyethylene oxide (PEO), and combinations thereof.

In one aspect, a mass ratio between the polytetrafluoroethylene (PTFE) binder and the ancillary binder may be about 0.5:5.

In various aspects, the present disclosure provides an electrochemical cell that cycles lithium ions. The electrochemical cell may include a positive electrode having a capacity loading of greater than or equal to about 4 mAh/cm² to less than or equal to about 10 mAh/cm², and a negative electrode having a capacity loading of greater than or equal to about 4.2 mAh/cm² to less than or equal to about 12 mAh/cm². The positive electrode may include greater than or equal to about 90 wt. % to less than or equal to about 98 wt. % of a cobalt-free electroactive material. The cobalt-free electroactive material may be represented by LiNiₓM₁₋ₓO₂, where M is manganese, aluminum, magnesium, zirconium, chromium, or a combination thereof, where x≥0.75. The positive electrode may also include greater than or equal to about 0.05 wt. % to less than or equal to about 3 wt. % of a polytetrafluoroethylene (PTFE) binder having a molecular weight (MW) greater than or equal to about 6,000,000 u. The positive electrode may also include greater than or equal to about 1 wt. % to less than or equal to about 5 wt. % a first electronically conductive material. The negative electrode may include greater than or equal to about 90 wt. % to less than or equal to about 98 wt. % of a graphite-containing negative electroactive material. The negative electrode may also include greater than or equal to about 0.05 wt. % to less than or equal to about 3 wt. % of a polytetrafluoroethylene (PTFE) binder having a molecular weight (MW) greater than or equal to about 6,000,000 u. The negative electrode may also include greater than or equal to about 0.05 wt. % to less than or equal to about 2 wt. % of an ancillary binder. The negative electrode may also include greater than or equal to about 1 wt. % to less than or equal to about 5 wt. % of a second electronically conductive material.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a schematic illustration of an example electrochemical battery cell that includes a cobalt-free electrode in accordance with various aspects of the present disclosure;

FIG. 2 is a graphical illustration representing formation cycle at 25° C. of an example battery cell prepared in accordance with various aspects of the present disclosures, where the charging rate is C/20, the discharging rate is C/5, and the voltage range is between about 2.7 V to about 4.2 V;

FIG. 3 is a graphical illustration representing charging capabilities of an example battery cell prepared in accordance with various aspects of the present disclosures;

FIG. 4 is a graphical illustration representing a charging profile of an example battery cell prepared in accordance with various aspects of the present disclosures;

FIG. 5 is a graphical illustration representing discharge capabilities of an example battery cell prepared in accordance with various aspects of the present disclosures;

FIG. 6 is a graphical illustration representing a discharge profile of an example battery cell prepared in accordance with various aspects of the present disclosures; and

FIG. 7 is a graphical illustration representing cycle life of an example battery cell prepared in accordance with various aspects of the present disclosures.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected, or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

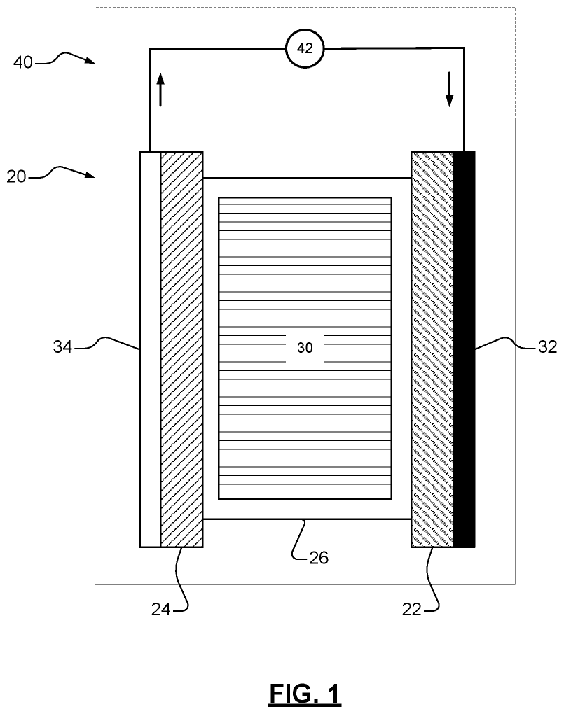

A typical lithium-ion battery includes a first electrode (such as a positive electrode or cathode) opposing a second electrode (such as a negative electrode or anode) and a separator and/or electrolyte disposed therebetween. Often, in a lithium-ion battery pack, batteries or cells may be electrically connected in a stack or winding configuration to increase overall output. Lithium-ion batteries operate by reversibly passing lithium ions between the first and second electrodes. For example, lithium ions may move from a positive electrode to a negative electrode during charging of the battery, and in the opposite direction when discharging the battery. The electrolyte is suitable for conducting lithium ions and may be in liquid, gel, or solid form. An exemplary and schematic illustration of an electrochemical cell (also referred to as the battery) 20 is shown in FIG. 1.

Such cells are used in vehicle or automotive transportation applications (e.g., motorcycles, boats, tractors, buses, motorcycles, mobile homes, campers, and tanks). However, the present technology may be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. Further, although the illustrated examples include a single positive electrode cathode and a single anode, the skilled artisan will recognize that the present teachings extend to various other configurations, including those having one or more cathodes and one or more anodes, as well as various current collectors with electroactive layers disposed on or adjacent to one or more surfaces thereof

The battery 20 includes a negative electrode 22 (e.g., anode), a positive electrode 24 (e.g., cathode), and a separator 26 disposed between the two electrodes 22, 24. The separator 26 provides electrical separation—prevents physical contact—between the electrodes 22, 24. The separator 26 also provides a minimal resistance path for internal passage of lithium ions, and in certain instances, related anions, during cycling of the lithium ions. In various aspects, the separator 26 comprises an electrolyte 30 that may, in certain aspects, also be present in the negative electrode 22 and positive electrode 24. In certain variations, the separator 26 may be formed by a solid-state electrolyte or a semi-solid-state electrolyte (e.g., gel electrolyte). For example, the separator 26 may be defined by a plurality of solid-state electrolyte particles (not shown). In the instance of solid-state batteries and/or semi-solid-state batteries, the positive electrode 24 and/or the negative electrode 22 may include a plurality of solid-state electrolyte particles (not shown). The plurality of solid-state electrolyte particles included in, or defining, the separator 26 may be the same as or different from the plurality of solid-state electrolyte particles included in the positive electrode 24 and/or the negative electrode 22.

A first current collector 32 (e.g., a negative current collector) may be positioned at or near the negative electrode 22. The first current collector 32 may be a metal foil, metal grid or screen, or expanded metal comprising copper or any other appropriate electronically conductive material known to those of skill in the art. A second current collector 34 (e.g., a positive current collector) may be positioned at or near the positive electrode 24. The second electrode current collector 34 may be a metal foil, metal grid or screen, or expanded metal comprising aluminum or any other appropriate electronically conductive material known to those of skill in the art. The first current collector 32 and the second current collector 34 may respectively collect and move free electrons to and from an external circuit 40. For example, an interruptible external circuit 40 and a load device 42 may connect the negative electrode 22 (through the first current collector 32) and the positive electrode 24 (through the second current collector 34).

The battery 20 can generate an electric current during discharge by way of reversible electrochemical reactions that occur when the external circuit 40 is closed (to connect the negative electrode 22 and the positive electrode 24) and the negative electrode 22 has a lower potential than the positive electrode. The chemical potential difference between the positive electrode 24 and the negative electrode 22 drives electrons produced by a reaction, for example, the oxidation of intercalated lithium, at the negative electrode 22 through the external circuit 40 toward the positive electrode 24. Lithium ions that are also produced at the negative electrode 22 are concurrently transferred through the electrolyte 30 contained in the separator 26 toward the positive electrode 24. The electrons flow through the external circuit 40 and the lithium ions migrate across the separator 26 containing the electrolyte 30 to form intercalated lithium at the positive electrode 24. As noted above, the electrolyte 30 is typically also present in the negative electrode 22 and positive electrode 24. The electric current passing through the external circuit 40 can be harnessed and directed through the load device 42 until the lithium in the negative electrode 22 is depleted and the capacity of the battery 20 is diminished.

The battery 20 can be charged or re-energized at any time by connecting an external power source to the lithium ion battery 20 to reverse the electrochemical reactions that occur during battery discharge. Connecting an external electrical energy source to the battery 20 promotes a reaction, for example, non-spontaneous oxidation of intercalated lithium, at the positive electrode 24 so that electrons and lithium ions are produced. The lithium ions flow back toward the negative electrode 22 through the electrolyte 30 across the separator 26 to replenish the negative electrode 22 with lithium (e.g., intercalated lithium) for use during the next battery discharge event. As such, a complete discharging event followed by a complete charging event is considered to be a cycle, where lithium ions are cycled between the positive electrode 24 and the negative electrode 22. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator.

In many lithium-ion battery configurations, each of the first current collector 32, negative electrode 22, separator 26, positive electrode 24, and second current collector 34 are prepared as relatively thin layers (for example, from several microns to a fraction of a millimeter or less in thickness) and assembled in layers connected in electrical parallel arrangement to provide a suitable electrical energy and power package. In various aspects, the battery 20 may also include a variety of other components that, while not depicted here, are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the separator 26. The battery 20 shown in FIG. 1 includes a liquid electrolyte 30 and shows representative concepts of battery operation. However, the present technology also applies to solid-state batteries and/or semi-solid state batteries that include solid-state electrolytes and/or solid-state electrolyte particles and/or semi-solid electrolytes and/or solid-state electroactive particles that may have different designs as known to those of skill in the art.

As noted above, the size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be powered by the electric current passing through the external circuit 40 when the battery 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for purposes of storing electrical energy.

With renewed reference to FIG. 1, the positive electrode 24, the negative electrode 22, and the separator 26 may each include an electrolyte solution or system 30 inside their pores, capable of conducting lithium ions between the negative electrode 22 and the positive electrode 24. Any appropriate electrolyte 30, whether in solid, liquid, or gel form, capable of conducting lithium ions between the negative electrode 22 and the positive electrode 24 may be used in the lithium-ion battery 20. For example, in certain aspects, the electrolyte 30 may be a non-aqueous liquid electrolyte solution that includes a lithium salt dissolved in an organic solvent or a mixture of organic solvents. Numerous conventional non-aqueous liquid electrolyte 30 solutions may be employed in the battery 20.

A non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiFSI), lithium bis(trifluoromethanesulfonyl)imide (LiTFSI), and combinations thereof.

In certain variations, the electrolyte 30 may include a first lithium salt like lithium hexafluorophosphate (LiPF₆) and one or more other (or second) lithium salts including, for example, lithium tetrafluoroborate (LiBF₄), lithium bis(fluorosulfonyl)imide (LiN(FSO₂)₂) (LiFSI), and/or lithium bis(trifluoromethanesulfonyl)imide (LiTFSI). In such instances, the electrolyte may include greater than or equal to about 0.8 mol/L to less than or equal to about 1.5 mol/L, and in certain aspects, optionally greater than or equal to 0.8 mol/L to less than or equal to 1.5 mol/L, of the first lithium salt, and greater than or equal to about 0 mol/L to less than or equal to about 0.7 mol/L, and in certain aspects, optionally greater than or equal to 0 mol/L to less than or equal to 0.7 mol/L, of the second lithium salt. In each instance, the electrolyte 30 may have a salt concentration greater than or equal to about 0.8 mol/L to less than or equal to about 1.5 mol/L, and in certain aspects, optionally greater than or equal to 0.8 mol/L to less than or equal to 1.5 mol/L. For example, in certain variations, the electrolyte 30 may include about 1.1 M of lithium hexafluorophosphate (LiPF₆) and about 0.1 M of lithium bis(fluorosulfonyl)imide (LiN(FSO₂)₂) (LiFSI).

The lithium salt(s) may be dissolved in a variety of non-aqueous aprotic organic solvents, including but not limited to, various alkyl carbonates, such as cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane, 1-2-diethoxyethane, ethoxymethoxyethane), cyclic ethers (e.g., tetrahydrofuran, 2-methyltetrahydrofuran), 1,3-dioxolane), sulfur compounds (e.g., sulfolane), and combinations thereof. For example, in certain instances, the electrolyte 30 may include a first solvent (like ethylene carbonate (EC)) and a second solvent (like ethylmethylcarbonate (EMC)), where a volumetric ratio of the first solvent to the second solvent is about 3:7.

In certain variations, the electrolyte 30 may include one or more electrolyte additives. For example, the electrolyte 30 may include greater than or equal to about 0.1 wt. % to less than or equal to about 10 wt. %, and in certain aspects, optionally greater than or equal to 0.1 wt. % to less than or equal to 10 wt. %, of the one or more electrolyte additives. The one or more electrolyte additives may be selected from the group consisting of: ethylene sulfate (DTD), vinylene carbonate (VC), lithium difluorophosphate (LiPF₂O₂), 1,3-propane sultone (PS), 3-sulfolene (3-SF), fluoroethylene carbonate (FEC), lithium tetraborate (LiTB), dimethylamide acetate (DMAc), trimethoxyboroxine (TMOBX), tosylmethyl isocyanide (TOSMIC), and combinations thereof. For example, in certain instances, the electrolyte 30 may include about 1 wt. % of vinylene carbonate (VC), about 2 wt. % of ethylene sulfate (DTD), and about 1 wt. % of lithium difluorophosphate (LiPF₂O₂).

In various aspects, the separator 26 may be a microporous polymeric separator having, for example, a porosity greater than or equal to about 30 vol. % to less than or equal to about 65 vol. %, and in certain aspects, optionally about 45 vol. %. In certain aspects, the separator 26 may have a porosity greater than or equal to 30 vol. % to less than or equal to 65 vol. %, and in certain aspects, optionally 45 vol. %. The microporous polymeric separator may include, for example, a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of polyethylene (PE) and polypropylene (PP), or multi-layered structured porous films of polyethylene (PE) and/or polypropylene (PP).

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 26 as a fibrous layer to help provide the separator 26 with appropriate structural and porosity characteristics.

Various conventionally available polymers and commercial products for forming the separator 26 are contemplated, as well as the many manufacturing methods that may be employed to produce such a microporous polymer separator 26. In each instance, the separator 26 may have an average thickness greater than or equal to about 5 μm to less than or equal to about 25 μm, and in certain instances, optionally about 20 μm. In certain variations, the separator 26 may have an average thickness greater than or equal to 5 μm to less than or equal to 25 μm, and in certain instances, optionally 20 μm.

In each variation, the separator 26 may further include one or more ceramic materials and/or one or more heat-resistant materials. For example, the separator 26 may also be admixed with the one or more ceramic materials and/or the one or more heat-resistant materials, or one or more surfaces of the separator 26 may be coated with the one or more ceramic materials and/or the one or more heat-resistant materials. The one or more ceramic materials may include, for example, alumina (Al₂O₃), silica (SiO₂), and the like. The heat-resistant material may include, for example, Nomex, Aramid, and the like.

In various aspects, the porous separator 26 and/or the electrolyte 30 disposed in the porous separator 26 as illustrated in FIG. 1 may be replaced with a solid-state electrolyte (“SSE”) layer (not shown) and/or semi-solid-state electrolyte (e.g., gel) layer that functions as both an electrolyte and a separator. The solid-state electrolyte layer and/or semi-solid-state electrolyte layer may be disposed between the positive electrode 24 and negative electrode 22. The solid-state electrolyte layer and/or semi-solid-state electrolyte layer facilitates transfer of lithium ions, while mechanically separating and providing electrical insulation between the negative and positive electrodes 22, 24. By way of non-limiting example, the solid-state electrolyte layer and/or semi-solid-state electrolyte layer may include a plurality of solid-state electrolyte particles, such as LiTi₂(PO₄)₃, LiGe₂(PO₄)₃, Li₇La₃Zr₂O₁₂, Li₃xLa_{2/3}-xTiO₃, Li₃PO₄, Li₃N, Li₄GeS₄, Li₁₀GeP₂S₁₂, Li₂S—P₂S₅, Li₆PS₅Cl, Li₆PS₅Br, Li₆PS₅I, Li₃OCl, Li_{2.99}Ba_{0.005}ClO, or combinations thereof. The solid-state electrolyte layer and/or semi-solid-state electrolyte layer may also include gel polymer electrolytes (polymer films with absorbed liquid electrolyte). Examples of the polymers include polyvinylidene difluoride, polyethylene glycol, polyacrylonitrile, poly(methyl methacrylate), their copolymers or combinations therefor.

The negative electrode 22 may be formed from a lithium host material that is capable of functioning as a negative terminal of the battery 20. In various aspects, the negative electrode 22 may be defined by a plurality of negative electroactive material particles (not shown). Such negative electroactive material particles may be disposed in one or more layers so as to define the three-dimensional structure of the negative electrode 22. The negative electroactive material particles may have an average diameter (D50) greater than or equal to about 4 μm to less than or equal to about 30 μm, and in certain aspects, optionally about 14 μm. In certain variations, the negative electroactive material particles may have an average diameter (D50) greater than or equal to 4 μm to less than or equal to 30 μm, and in certain aspects, optionally 14 μm.

Space or voids between the negative electroactive material particles define a negative electrode porosity. For example, the negative electrode 22 may have a porosity greater than or equal to about 28 vol. % to less than or equal to about 50 vol. %, optionally greater than or equal to about 28 vol. % to less than or equal to about 42 vol. %, and in certain aspects, optionally about 40 vol. %. In certain variations, the negative electrode 22 may have a porosity greater than or equal to 28 vol. % to less than or equal to 50 vol. %, optionally greater than or equal to 28 vol. % to less than or equal to 42 vol. %, and in certain aspects, optionally 40 vol. %. The electrolyte 30 may be introduced, for example after cell assembly, and contained within pores (not shown) of the negative electrode 22. In certain variations, the negative electrode 22 may include a plurality of solid-state electrolyte particles (not shown), and the porosity may be defined between both the negative electroactive material particles and the solids-state electrolyte particles.

In various aspects, the negative electroactive material may be a carbonaceous material (such as, graphite) and/or silicon-containing material (such as, SiOₓ, Si, LiSiOₓ, and the like). In such instances, the negative electrode 22 further includes a polytetrafluoroethylene (PTFE) binder. The polytetrafluoroethylene (PTFE) binder may have a molecular weight (MW) greater than or equal to about 6,000,000 u, optionally greater than or equal to about 10,000,000 u, optionally greater than or equal to about 50,000,000 u, optionally greater than or equal to about 100,000,000 u, optionally greater than or equal to about 150,000,000 u, optionally greater than or equal to about 200,000,000 u, optionally greater than or equal to about 250,000,000 u, optionally greater than or equal to about 300,000,000 u, optionally greater than or equal to about 350,000,000 u, optionally greater than or equal to about 400,000,000 u, optionally greater than or equal to about 450,000,000 u, optionally greater than or equal to about 500,000,000 u, optionally greater than or equal to about 550,000,000 u, optionally greater than or equal to about 600,000,000 u, optionally greater than or equal to about 650,000,000 u, optionally greater than or equal to about 700,000,000 u, optionally greater than or equal to about 750,000,000 u, and in certain aspects, optionally about 800,000,000 u.

In certain variations, the polytetrafluoroethylene (PTFE) binder may have a molecular weight greater than or equal to 6,000,000 u, optionally greater than or equal to 10,000,000 u, optionally greater than or equal to 50,000,000 u, optionally greater than or equal to 100,000,000 u, optionally greater than or equal to 150,000,000 u, optionally greater than or equal to 200,000,000 u, optionally greater than or equal to 250,000,000 u, optionally greater than or equal to 300,000,000 u, optionally greater than or equal to 350,000,000 u, optionally greater than or equal to 400,000,000 u, optionally greater than or equal to 450,000,000 u, optionally greater than or equal to 500,000,000 u, optionally greater than or equal to 550,000,000 u, optionally greater than or equal to 600,000,000 u, optionally greater than or equal to 650,000,000 u, optionally greater than or equal to 700,000,000 u, optionally greater than or equal to 750,000,000 u, and in certain aspects, optionally 800,000,000 u

In each instance, the negative electrode 22 may also optionally include one or more electronically conductive materials (or carbon additives) and one or more other (or second) binders. For example, the negative electrode 22 may include greater than or equal to about 90 wt. % to less than or equal to about 98 wt. %, optionally greater than or equal to about 92 wt. % to less than or equal to about 98 wt. %, and in certain aspects, optionally about 95.75 wt. %, of the graphite; greater than or equal to about 0.05 wt. % to less than or equal to about 3 wt. %, and in certain aspects, optionally about 1 wt. %, of the polytetrafluoroethylene (PTFE) binder; greater than or equal to 0 wt. % to less than or equal to about 5 wt. %, optionally greater than or equal to about 1 wt. % to less than or equal to about 5 wt. %, and in certain aspects, optionally about 2 wt. %, of the one or more electronically conductive materials; and greater than or equal to 0 wt. % to less than or equal to about 2 wt. %, optionally greater than or equal to about 0.05 wt. % to less than or equal to about 2 wt. %, and in certain aspects, optionally about 1.25 wt. %, of the one or more other binders. A mass ratio between the polytetrafluoroethylene (PTFE) binder and the other binder(s) may be about 0.5:5.0.

In certain variations, the negative electrode 22 may include greater than or equal to 90 wt. % to less than or equal to 98 wt. %, optionally greater than or equal to 92 wt. % to less than or equal to 98 wt. %, and in certain aspects, optionally 95.75 wt. %, of the graphite; greater than or equal to 0.05 wt. % to less than or equal to 3 wt. %, and in certain aspects, optionally 1 wt. %, of the polytetrafluoroethylene (PTFE) binder; greater than or equal to 0 wt. % to less than or equal to 5 wt. %, optionally greater than or equal to 1 wt. % to less than or equal to 5 wt. %, and in certain aspects, optionally 2 wt. %, of the one or more electronically conductive materials; and greater than or equal to 0 wt. % to less than or equal to 2 wt. %, optionally greater than or equal to 0.05 wt. % to less than or equal to 2 wt. %, and in certain aspects, optionally 1.25 wt. %, of the one or more other binders. A mass ratio between the polytetrafluoroethylene (PTFE) binder and the other binder(s) may be 0.5:1.0.

The one or more electronically conductive materials (or carbon additives) may include, for example, particles of graphite, acetylene black (such as KETCHEN™ black or DENKA™ black), carbon nanofibers and nanotubes (e.g., single wall carbon nanotubes (SWCNT), multiwall carbon nanotubes (MWCNT)), graphene (e.g., graphene platelets (GNP), oxidized graphene platelets), conductive carbon blacks (such as, SuperP (SP)), and the like.

The and one or more other (or second) binders may include, for example, polyimide, polyamic acid, polyamide, polysulfone, polyacrylic acid, blends of polyvinylidene fluoride and polyhexafluoropropene, polychlorotrifluoroethylene, ethylene propylene diene monomer (EPDM) rubber, carboxymethyl cellulose (CMC), a nitrile butadiene rubber (NBR), styrene-butadiene rubber (SBR), lithium polyacrylate (LiPAA), sodium polyacrylate (NaPAA), sodium alginate, lithium alginate, polyethylene oxide (PEO), and the like. The one or more other (or second) binders may differ from the polytetrafluoroethylene (PTFE) binder insofar as the polytetrafluoroethylene (PTFE) binder forms points or line contacts with a surface of the electroactive material allowing lithium ions to readily flow between the surface of the electroactive material, and the electrolyte 30 and the one or more other (or second) binders form facial contacts with (i.e., coats a portion of) the surface of the electroactive material, and as such, blocks the passageways between the electroactive material and the electrolyte 30. The one or more other (or second) binders may be included in the current instance, however, so as to limit side reactions within the negative electrode 22.

In each variation, the negative electrode 22 may have a press density greater than or equal to about 1.3 g/cm³ to less than or equal to about 1.9 g/cm³, and in certain aspects, optionally about 1.4 g/cm³. In certain variations, the negative electrode 22 may have a press density greater than or equal to about 1.3 g/cm³ to less than or equal to about 1.9 g/cm³, and in certain aspects, optionally about 1.4 g/cm³.

In each variation, the negative electrode 22 may have a tap density greater than or equal to about 0.5 g/cc to less than or equal to about 1.3 g/cc, and in certain aspects, optionally about 0.96 g/cc. In certain variations, the negative electrode 22 may have a tap density greater than or equal to 0.5 g/cc to less than or equal to 1.3 g/cc, and in certain aspects, optionally 0.96 g/cc.

In each variation, the negative electrode 22 may have a Brunauer, Emmett and Teller (“BET”) greater than or equal to about 0.1 m² to less than or equal to about 10 m², and in certain aspects, optionally about 0.91 m². In certain variations, the negative electrode 22 may have a Brunauer, Emmett and Teller (“BET”) greater than or equal to 0.1 m² to less than or equal to 10 m², and in certain aspects, optionally 0.91 m².

In each variation, the negative electrode 22 may have a capacity loading greater than or equal to about 4.2 mAh/cm² to less than or equal to about 12 mAh/cm², optionally greater than or equal to about 4.5 mAh/cm² to less than or equal to about 6.5 mAh/cm², and in certain aspects, optionally about 5.2 mAh/cm², for a single-sided anode 0.1 C-rate at room temperature (e.g., about 25° C.). In certain variations, the negative electrode 22 may have a capacity loading greater than or equal to 4.2 mAh/cm² to less than or equal to 12 mAh/cm², optionally greater than or equal to 4.5 mAh/cm² to less than or equal to 6.5 mAh/cm², and in certain aspects, optionally 5.2 mAh/cm², for a single-sided anode 0.1 C-rate at room temperature (e.g., about 25° C.).

In each variation, the negative electrode 22 may have a width greater than or equal to about 50 mm to less than or equal to about 500 mm, and in certain aspects, optionally about 52 mm; and a length greater than or equal to about 50 mm to less than or equal to about 2,000 mm, and in certain aspects, optionally about 57 mm. In certain variations, the negative electrode 22 may have a width greater than or equal to 50 mm to less than or equal to 500 mm, and in certain aspects, optionally 52 mm; and a length greater than or equal to 50 mm to less than or equal to 2,000 mm, and in certain aspects, optionally 57 mm. As the skilled artisan will recognize, the length is a distance from a first end or side of the negative electrode 22 to a second end or side of the negative electrode 22 having, for example, a battery tab.

Notably, the negative electrode 22 has a (first) width that is greater than a (second) width of the positive electrode 24. For example, the (first) width of the negative electrode 22 may be at least about 2 mm greater than the (second) width of the positive electrode 24. The (first) width of the negative electrode 22 may be at least 2 mm greater than the (second) width of the positive electrode 24. The (first) width of the negative electrode 22 may be less than about 10 mm greater than the (second) width of the positive electrode 24. The (first) width of the negative electrode 22 may be less than 10 mm greater than the (second) width of the positive electrode 24.

Similarly, the negative electrode 22 may have a (first) length that is greater than a (second) length of the positive electrode 24. The (first) length of the negative electrode 22 may be at least about 2 mm greater than the (second) length of the positive electrode 24. The (first) length of the negative electrode 22 may be at least 2 mm greater than the (second) length of the positive electrode 24. The (first) length of the negative electrode 22 may be less than about 10 mm greater than the (second) length of the positive electrode 24. The (first) length of the negative electrode 22 may be less than 10 mm greater than the (second) length of the positive electrode 24.

The positive electrode 24 may be formed from a lithium-based active material that is capable of undergoing lithium intercalation and deintercalation, alloying and dealloying, or plating and stripping, while functioning as the positive terminal of the battery 20. The positive electrode 24 can be defined by a plurality of electroactive material particles (not shown). Such positive electroactive material particles may be disposed in one or more layers so as to define the three-dimensional structure of the positive electrode 24. The positive electroactive material particles may have an average diameter (D50) greater than or equal to about 3 μm to less than or equal to about 30 μm, and in certain aspects, optionally about 6 μm. In certain variations, the positive electroactive material particles may have an average diameter (D50) greater than or equal to 3 μm to less than or equal to 30 μm, and in certain aspects, optionally 6 μm.

Spaces or voids between the positive electroactive material particles define a positive electrode porosity. For example, the positive electrode 24 may have a porosity greater than or equal to about 25 vol. % to less than or equal to about 45 vol. %, and in certain aspects, optionally about 34 vol. %. In certain variations, the positive electrode 24 may have a porosity greater than or equal to 25 vol. % to less than or equal to 45 vol. %, and in certain aspects, optionally 34 vol. %. The electrolyte 30 may be introduced, for example after cell assembly, and contained within pores (not shown) of the positive electrode 24. In certain variations, the positive electrode 24 may include a plurality of solid-state electrolyte particles (not shown), and the porosity may be defined between both the positive electroactive material particles and the solid-state electrolyte particles.

In various aspects, the positive electroactive material may be a cobalt free material having a single crystal or secondary particle morphology—that is, the positive electroactive material may have a large primary particle morphology (e.g., greater than or equal to about 4 μm to less than or equal to about 8 μm, and in certain aspects, optionally greater than or equal to 4 μm to less than or equal to 8 μm) and a substantially smooth surface. The positive electroactive material may have a layered or rock-salt structure and may be represented by the general formula LiNiₓM₁₋ₓO₂, where M is manganese, aluminum, magnesium, zirconium, chromium, or a combination thereof and x≥0.75. For example, the positive electroactive material may be LiNi_{0.75}Mn_{0.25}O₂ (NM75) or LiNi_{0.94}Mn_{0.04}Al_{0.02}O₂ (NMA). Cobalt free positive electroactive materials provide notable cost savings. In certain variations, the positive electrode 24 includes traces amounts of cobalt, for example, of less than or equal to about 1,000 ppm.

The positive electrode 24 further includes a polytetrafluoroethylene (PTFE) binder having a molecular weight (MW) greater than or equal to about 6,000,000 u, optionally greater than or equal to about 10,000,000 u, optionally greater than or equal to about 50,000,000 u, optionally greater than or equal to about 100,000,000 u, optionally greater than or equal to about 150,000,000 u, optionally greater than or equal to about 200,000,000 u, optionally greater than or equal to about 250,000,000 u, optionally greater than or equal to about 300,000,000 u, optionally greater than or equal to about 350,000,000 u, optionally greater than or equal to about 400,000,000 u, optionally greater than or equal to about 450,000,000 u, optionally greater than or equal to about 500,000,000 u, optionally greater than or equal to about 550,000,000 u, optionally greater than or equal to about 600,000,000 u, optionally greater than or equal to about 650,000,000 u, optionally greater than or equal to about 700,000,000 u, optionally greater than or equal to about 750,000,000 u, and in certain aspects, optionally about 800,000,000 u

In certain variations, the polytetrafluoroethylene (PTFE) binder may have a molecular weight greater than or equal to 6,000,000 u, optionally greater than or equal to 10,000,000 u, optionally greater than or equal to 50,000,000 u, optionally greater than or equal to 100,000,000 u, optionally greater than or equal to 150,000,000 u, optionally greater than or equal to 200,000,000 u, optionally greater than or equal to 250,000,000 u, optionally greater than or equal to about 300,000,000 u, optionally greater than or equal to 350,000,000 u, optionally greater than or equal to 400,000,000 u, optionally greater than or equal to 450,000,000 u, optionally greater than or equal to 500,000,000 u, optionally greater than or equal to 550,000,000 u, optionally greater than or equal to 600,000,000 u, optionally greater than or equal to 650,000,000 u, optionally greater than or equal to 700,000,000 u, optionally greater than or equal to 750,000,000 u, and in certain aspects, optionally 800,000,000 u.

In each instance, the positive electrode 24 may also optionally include one or more electronically conductive materials (or carbon additives). For example, the positive electrode 24 may include greater than or equal to about 90 wt. % to less than or equal to about 98 wt. %, and in certain aspects, optionally about 96 wt. % of the cobalt-free positive electroactive material; greater than or equal to about 1 wt. % to less than or equal to about 5 wt. %, and in certain aspects, optionally about 2 wt. %, of the polytetrafluoroethylene (PTFE); and greater than or equal to about 1 wt. % to less than or equal to about 5 wt. % , and in certain aspects, optionally about 2 wt. %, of the one or more electronically conductive materials. In certain variations, the positive electrode 24 may include greater than or equal to 90 wt. % to less than or equal to 98 wt. %, and in certain aspects, optionally 96 wt. % of the cobalt-free positive electroactive material;

greater than or equal to 1 wt. % to less than or equal to wt. %, and in certain aspects, optionally 2 wt. %, of the polytetrafluoroethylene (PTFE); and greater than or equal to 1 wt. % to less than or equal to 5 wt. % , and in certain aspects, optionally 2 wt. %, of the one or more electronically conductive materials.

The one or more electronically conductive materials (or carbon additives) may include, for example, particles of graphite, acetylene black (such as KETCHEN™ black or DENKA™ black), carbon nanofibers and nanotubes (e.g., single wall carbon nanotubes (SWCNT), multiwall carbon nanotubes (MWCNT)), graphene (e.g., graphene platelets (GNP), oxidized graphene platelets), conductive carbon blacks (such as, SuperP (SP)), and the like.

In each variation, the positive electrode 24 may have a press density greater than or equal to about 2.5 g/cm³ to less than or equal to about 4.0 g/cm³, and in certain aspects, optionally about 3.0 g/cm³. In certain variations, the positive electrode 24 may have a press density greater than or equal to 2.5 g/cm³ to less than or equal to 4.0 g/cm³, and in certain aspects, optionally 3.0 g/cm³.

In each variation, the positive electrode 24 may have a capacity loading greater than or equal to about 4.0 mAh/cm² to less than or equal to about 10 mAh/cm², optionally greater than or equal to about 4.5 mAh/cm² to less than or equal to about 5.5 mAh/cm², and in certain aspects, optionally about 4.75 mAh/cm², for a single-sided cathode 0.1 C-rate at room temperature (e.g., about 25° C.). In certain variations, the positive electrode 24 may have a capacity loading greater than or equal to 4.0 mAh/cm² to less than or equal to 10 mAh/cm², optionally greater than or equal to 4.5 mAh/cm² to less than or equal to 5.5 mAh/cm², and in certain aspects, optionally 4.75 mAh/cm², for a single-sided cathode 0.1 C-rate at room temperature (e.g., about 25° C.).

In each variation, the positive electrode 24 may have a width greater than or equal to about 50 mm to less than or equal to about 500 mm, and in certain aspects, optionally about 50 mm; and a length greater than or equal to about 50 mm to less than or equal to about 2,000 mm, and in certain aspects, optionally about 55 mm. In certain variations, the positive electrode 24 may have a width greater than or equal to 50 mm to less than or equal to 500 mm, and in certain aspects, optionally 50 mm; and a length greater than or equal to 50 mm to less than or equal to 2,000 mm, and in certain aspects, optionally 55 mm. As the skilled artisan will recognize, the length is a distance from a first end or side of the positive electrode 24 to a second end or side of the positive electrode 24 having, for example, a battery tab.

In each variation, the positive electrode 24 may have a moisture content of less than about 600 ppm, and in certain aspects, optionally less than 600 ppm.

Certain features of the current technology are further illustrated in the following non-limiting examples.

### EXAMPLE 1

Example battery cells may be prepared in accordance with various aspects of the present disclosure. For example, an electrochemical cell may include a positive electrode (or cathode) including about 96 wt. % of LiNi_{0.75}Mn_{0.25}O₂ (NM75), about 1 wt. % of a first electronically conductive material (e.g., SuperP (SP)), about 1 wt. % of a second electronically conductive material (e.g., Ketjen Black (KB)), and about 2 wt. % of a polytetrafluoroethylene (PTFE) binder having a molecular weight (MW) of greater than or equal to about 6 million; and a negative electrode (or anode) including about 95.75 wt. % of graphite, about 1 wt. % of a first electronically conductive material (e.g., SuperP (SP)), about 1 wt. % of a second electronically conductive material (e.g., carbon nanotubes (CNT)), about 1 wt. % of a polytetrafluoroethylene (PTFE) binder, and about 1.25 wt. % of another binder (e.g., polyethylene oxide (PEO)). The positive electrode may have a capacity loading of about 4.75 mAh/cm², and the negative electrode may have a capacity loading of about 5.17 mAh/cm².

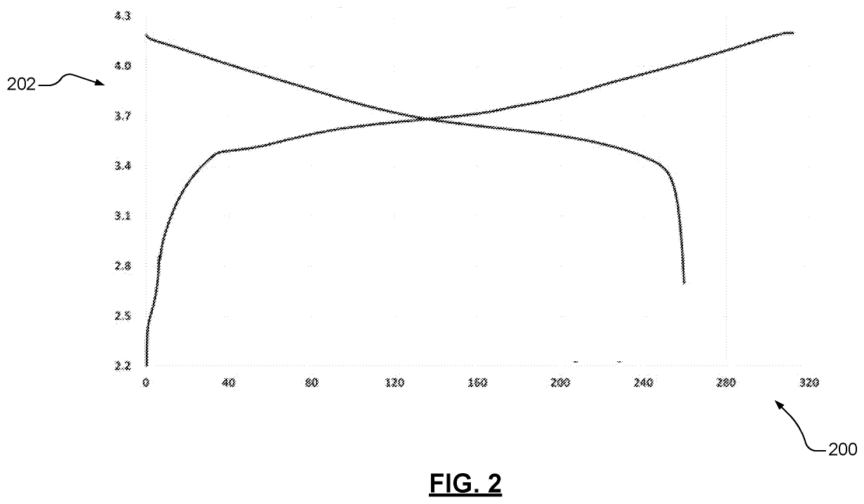

FIG. 2 is a graphical illustration representing the formation cycle of the cell, charging rate is C/20 and the discharging rate is C/5, the voltage range is between about 2.7 V to about 4.2 V at 25° C. of the example battery cell, where the x-axis 200 represents capacity (mAh), and the y-axis 202 represents voltage (V). As illustrated, the cell capacity is about 260 mAh and the initial columbic efficiency is about 83.2%.

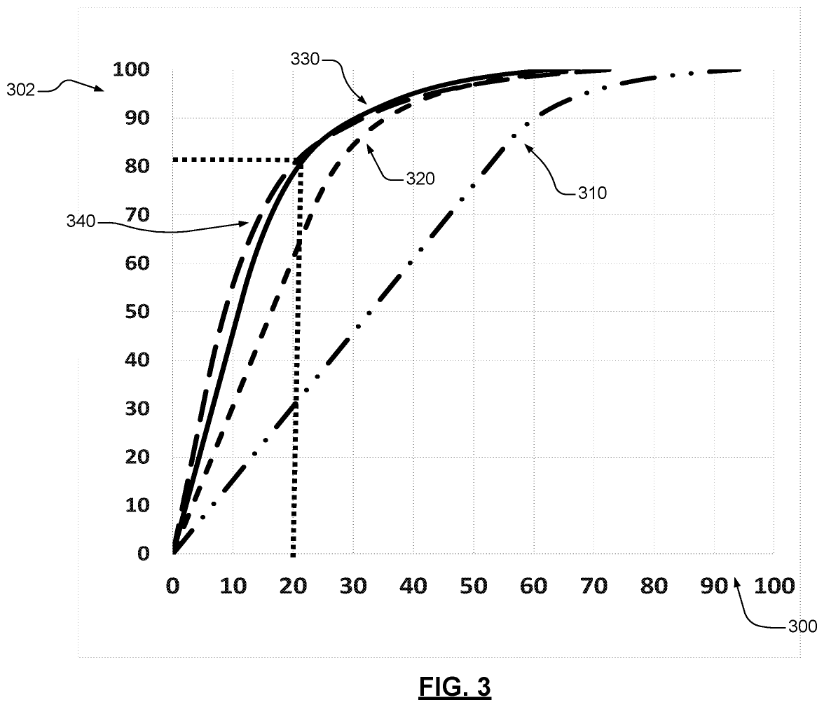

FIG. 3 is a graphical illustration representing charging capabilities at 25° C. of the example battery cell, where the x-axis 300 represents time (minutes), and the y-axis 302 represents state of charge (%). Line 310 represents the state of charge of the first cycle. Line 320 represents the state of charge of the second cycle. Line 330 represents the state of charge of the third cycle. Line 340 represents the state of charge of the fourth cycle. As illustrated, the example cell has a state of charge of about 80% after about 20 minutes.

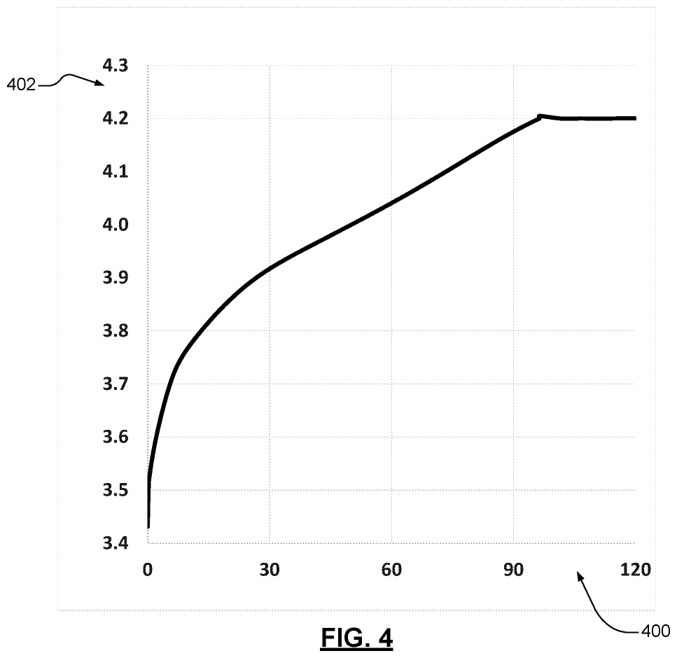

FIG. 4 is a graphical illustration representing a charging profile of the example battery cell, where the x-axis 400 represents capacity (mAh), and the y-axis 402 represents voltage (V). As illustrated, at a 4 C charging rate, the constant current capacity (e.g., 96 mAh) is about 80% of total capacity (e.g., constant current capacity plus constant voltage capacity, which is about 120 mAh).

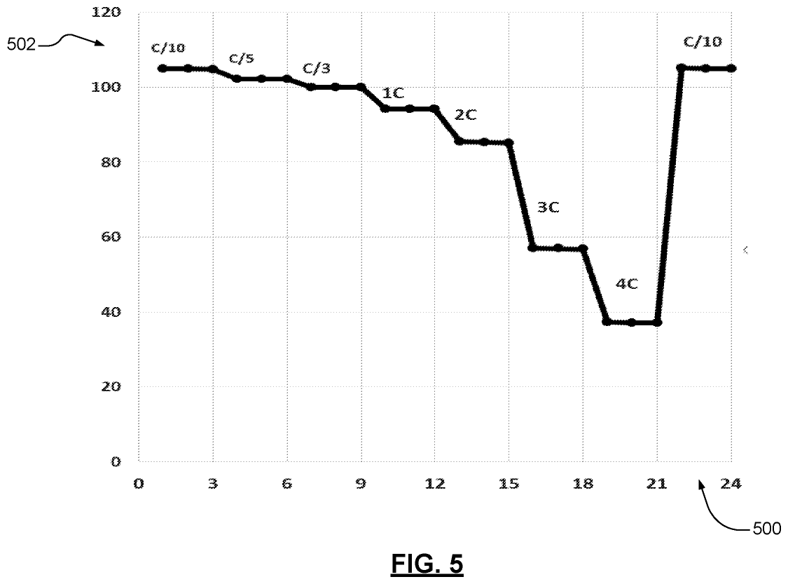

FIG. 5 is a graphical illustration representing discharge capabilities of the example battery cell, where the x-axis 500 represents cycle number, and the y-axis 502 represents discharge capacity ratio. As illustrated, at a 2 C discharge rate, the cell delivered about 85% capacity of that at C/3, at 3 C discharge rate, the cell delivered about 56% capacity of that at C/3, and at 4 C discharge rate, the cell delivered about 37% capacity of that at C/3.

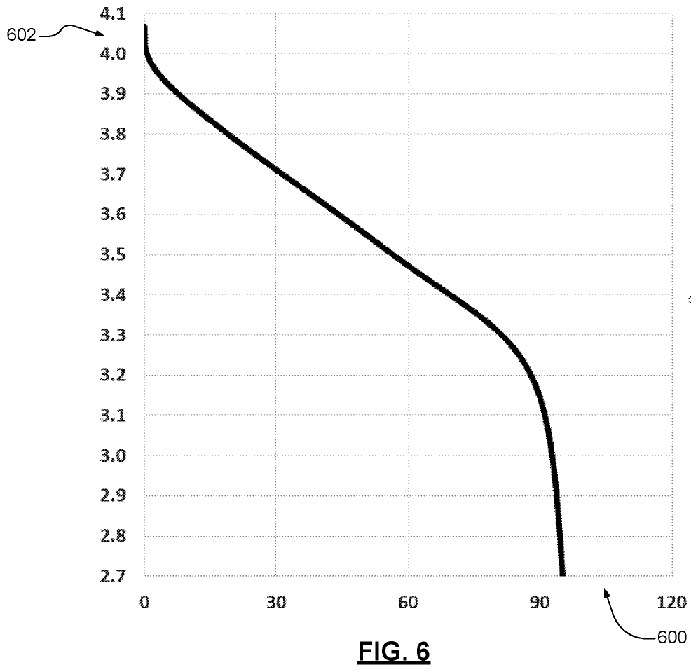

FIG. 6 is a graphical illustration representing a discharge profile of the example battery cell, where the x-axis 600 represents capacity (mAh), and the y-axis 602 represents voltage (V). As illustrated, at 4 C rate, the cell discharge voltage has little change compared with 1 C rate and can deliver about 95 mAh capacity at 4 C rate.

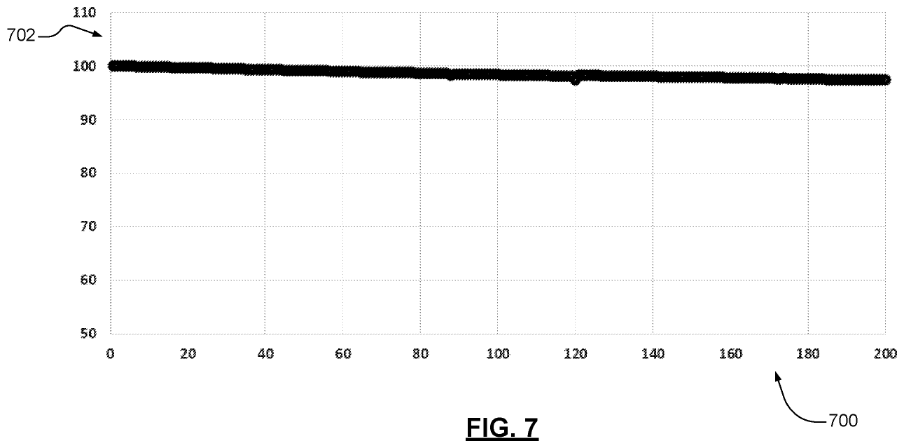

FIG. 7 is a graphical illustration representing cycle life of the example battery cell, where the x-axis 700 represents cycle number, and the y-axis represents discharge capacity retention (%). As illustrated, after about 200 cycles, the example cell has a capacity retention of about 97.4%.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electrochemical cell that cycles lithium ions, wherein the electrochemical cell comprises:
a positive electrode comprising a cobalt-free electroactive material represented by LiNiₓM₁₋ₓO₂, where M is selected from the group consisting of: manganese, aluminum, magnesium, zirconium, chromium, and combinations thereof, where x≥0.75, and a polytetrafluoroethylene (PTFE) binder having a molecular weight (MW) greater than or equal to about 6,000,000 u; and
a negative electrode comprising a graphite-containing negative electroactive material and a polytetrafluoroethylene (PTFE) binder having a molecular weight (MW) greater than or equal to about 6,000,000 u.

2. The electrochemical cell of claim 1, wherein the positive electrode comprises:
greater than or equal to about 90 wt. % to less than or equal to about 98 wt. % of the cobalt-free electroactive material; and
greater than or equal to about 1 wt. % to less than or equal to about 5 wt. % of the high molecular weight polytetrafluoroethylene (PTFE) binder.

3. The electrochemical cell of claim 1, wherein the positive electrode further comprises:
greater than or equal to about 1 wt. % to less than or equal to about 5 wt. % of an electronically conductive material.

4. The electrochemical cell of claim 1, wherein the negative electrode comprises:
greater than or equal to about 90 wt. % to less than or equal to about 98 wt. % of the graphite-containing negative electroactive material; and
greater than or equal to about 0.05 wt. % to less than or equal to about 3 wt. % of the polytetrafluoroethylene (PTFE) binder.

5. The electrochemical cell of claim 1, wherein the negative electrode further comprises:
greater than or equal to about 0.05 wt. % to less than or equal to about 2 wt. % of an ancillary binder.

6. The electrochemical cell of claim 5, wherein the ancillary binder is selected from the group consisting of: polyimide, polyamic acid, polyamide, polysulfone, polyvinylidene difluoride (PVdF), polyacrylic acid, blends of polyvinylidene fluoride and polyhexafluoropropene, polychlorotrifluoroethylene, ethylene propylene diene monomer (EPDM) rubber, carboxymethyl cellulose (CMC), a nitrile butadiene rubber (NBR), styrene-butadiene rubber (SBR), lithium polyacrylate (LiPAA), sodium polyacrylate (NaPAA), sodium alginate, lithium alginate, polyethylene oxide (PEO), and combinations thereof.

7. The electrochemical cell of claim 1, wherein a mass ratio between the polytetrafluoroethylene (PTFE) binder and the ancillary binder is about 0.5:5.

8. The electrochemical cell of claim 1, wherein the negative electrode further comprises:
greater than or equal to 1 wt. % to less than or equal to about 5 wt. % of an electronically conductive material.

9. The electrochemical cell of claim 1, wherein the positive electrode has a capacity loading of greater than or equal to about 4.0 mAh/cm² to less than or equal to about 10 mAh/cm², and the negative electrode has a capacity loading of greater than or equal to about 4.2 mAh/cm² to less than or equal to about 12 mAh/cm².

10. The electrochemical cell of claim 1, wherein the positive electrode has a press density greater than or equal to about 2.5 g/cm³ to less than or equal to about 4.0 g/cm³, and a porosity greater than or equal to about 25 vol. % to less than or equal to about 45 vol. %.

11. The electrochemical cell of claim 1, wherein the negative electrode has a tap density greater than or equal to 0.5 g/cc to less than or equal to 1.3 g/cc, a press density greater than or equal to about 1.3 g/cm³ to less than or equal to about 1.9 g/cm³, and a porosity greater than or equal to about 28 vol. % to less than or equal to about 50 vol. %.

12. The electrochemical cell of claim 1, wherein the positive electrode has a first width greater than or equal to about 50 mm to less than or equal to about 500 mm, and a first length greater than or equal to about 50 mm to less than or equal to about 2,000 mm, and
wherein the negative electrode has a second width that is at least two times greater than a first width of the positive electrode, and a second length that is at least two times greater than a first length of the positive electrode.

13. The electrochemical cell of claim 1, wherein the cobalt-free electroactive material comprises LiNi_{0.75}Mn_{0.2}O₂ (NM75).

14. The electrochemical cell of claim 1, wherein the cobalt-free electroactive material comprises LiNi_{0.94}Mn_{0.04}Al_{0.02}O_{2 (NMA).}

15. An electrochemical cell that cycles lithium ions, wherein the electrochemical cell comprises:
a positive electrode comprising:
greater than or equal to about 90 wt. % to less than or equal to about 98 wt. % of a cobalt-free electroactive material represented by LiNiₓM₁₋ₓO₂, where M is manganese, aluminum, magnesium, zirconium, chromium, and a combination thereof, where x≥0.75, and
greater than or equal to about 0.05 wt. % to less than or equal to about 3 wt. % of a polytetrafluoroethylene (PTFE) binder having a molecular weight (MW) greater than or equal to about 6,000,000 u; and
a negative electrode comprising:
greater than or equal to about 90 wt. % to less than or equal to about 98 wt. % of a graphite-containing negative electroactive material,
greater than or equal to about 0.05 wt. % to less than or equal to about 3 wt. % of a polytetrafluoroethylene (PTFE) binder having a molecular weight (MW) greater than or equal to about 6,000,000 u, and
greater than or equal to about 0.05 wt. % to less than or equal to about 2 wt. % of an ancillary binder.

16. The electrochemical cell of claim 15, wherein the positive electrode further comprises:
greater than or equal to about 1 wt. % to less than or equal to about 5 wt. % of an electronically conductive material.

17. The electrochemical cell of claim 15, wherein the negative electrode further comprises:
greater than or equal to 1 wt. % to less than or equal to about 5 wt. % of an electronically conductive material.

18. The electrochemical cell of claim 15, wherein the ancillary binder is selected from the group consisting of: polyimide, polyamic acid, polyamide, polysulfone, polyvinylidene difluoride (PVdF), polyacrylic acid, blends of polyvinylidene fluoride and polyhexafluoropropene, polychlorotrifluoroethylene, ethylene propylene diene monomer (EPDM) rubber, carboxymethyl cellulose (CMC), a nitrile butadiene rubber (NBR), styrene-butadiene rubber (SBR), lithium polyacrylate (LiPAA), sodium polyacrylate (NaPAA), sodium alginate, lithium alginate, polyethylene oxide (PEO), and combinations thereof.

19. The electrochemical cell of claim 15, wherein a mass ratio between the polytetrafluoroethylene (PTFE) binder and the ancillary binder is about 0.5:5.

20. An electrochemical cell that cycles lithium ions, wherein the electrochemical cell comprises:
a positive electrode having a capacity loading of greater than or equal to about 4 mAh/cm² to less than or equal to about 10 mAh/cm² that comprises:
greater than or equal to about 90 wt. % to less than or equal to about 98 wt. % of a cobalt-free electroactive material represented by LiNiₓM₁₋ₓO₂, where M is manganese, aluminum, magnesium, zirconium, chromium, or a combination thereof, where x≥0.75;
greater than or equal to about 0.05 wt. % to less than or equal to about 3 wt. % of a polytetrafluoroethylene (PTFE) binder having a molecular weight (MW) greater than or equal to about 6,000,000 u, and
greater than or equal to about 1 wt. % to less than or equal to about 5 wt. % a first electronically conductive material; and
a negative electrode having a capacity loading of greater than or equal to about 4.2 mAh/cm² to less than or equal to about 12 mAh/cm² that comprises:
greater than or equal to about 90 wt. % to less than or equal to about 98 wt. % of a graphite-containing negative electroactive material,
greater than or equal to about 0.05 wt. % to less than or equal to about 3 wt. % of a polytetrafluoroethylene (PTFE) binder having a molecular weight (MW) greater than or equal to about 6,000,000 u,
greater than or equal to about 0.05 wt. % to less than or equal to about 2 wt. % of an ancillary binder, and
greater than or equal to about 1 wt. % to less than or equal to about 5 wt. % of a second electronically conductive material.
